(19) United States
(12) Patent Application Publication
(10) Pub. No.: US 2011/0227917 A1
(43) Pub. Date: Sep. 22, 2011

(54) SYSTEM AND METHOD FOR USING OFF-SCREEN MASK SPACE TO PROVIDE ENHANCED VIEWING

(75) Inventors: Danny D. Lowe, Calgary (CA); Steven Birtwistle, Calgary (CA); Natascha Wallner, Calgary (CA); Christopher L. Simmons, Calgary (CA); Gregory R. Keech, Calgary (CA); Jonathan Adelman, Calgary (CA)

(73) Assignee: Conversion Works, Inc., Calgary (CA)

(21) Appl. No.: 13/118,089

(22) Filed: May 27, 2011

Related U.S. Application Data
(63) Continuation of application No. 11/937,827, filed on Nov. 9, 2007, now abandoned.
(60) Provisional application No. 60/894,450, filed on Mar. 12, 2007.

(51) Int. Cl. G06T 15/40; G09G 5/00

(52) U.S. Cl. 345/421; 345/629; 345/621

(57) ABSTRACT

Methods and apparatuses for compensating for clipped portions of one or more objects in an image provide a boundary mask portion adjacent to one or more edges of an image display. The boundary mask portion is used to display information which will fill clipped portions of the objects in the image.

### CROSS-REFERENCE TO RELATED APPLICATIONS

This application is a Continuation of U.S. patent application Ser. 11/937,827 filed on Nov. 9, 2007, entitled “A SYSTEM AND METHOD FOR USING OFF-SCREEN MASK SPACE TO PROVIDE ENHANCED VIEWING,” the disclosure of which are hereby incorporated by reference. The present application also claims priority benefit of U.S. Provisional Patent Application No. 60/894,450 entitled “TWO-DIMENSIONAL TO THREE-DIMENSIONAL CONVERSION,” filed Mar. 12, 2007, the disclosure of which is hereby incorporated herein by reference.

### TECHNICAL FIELD

The present application is directed towards three dimensional (3-D) displaying of images. More specifically, the present application is directed to 3-D imaging of an object which intersects a boundary of a display screen.

### BACKGROUND OF THE INVENTION

Viewing images and motion pictures in stereoscopic 3-D creates a realistic feel and look which gives a viewer an enhanced visual experience. As a result, the popularity stereoscopic 3-D viewing, such as in stereoscopic 3-D movie theaters, is drastically increasing.

Generally, three dimensional imagery is limited to the boundaries of the presentation screen that are deemed to be prime. In other words, images are limited to the 3-D space within screen area where imagery is reflected back to the viewer. Often times, the boundaries of the screen are usually defined by physical mask, such as a black curtain around the screen. Hence, the viewing experience is limited to positive or negative objects or visuals within the masked area of the screen.

Present stereoscopic 3-D imaging technology has the capability to display a tremendous amount of depth and detail of the images. However, when an object is conceptually occluded by a boundary of the screen, which is usually includes the black masked area, current 3-D imaging techniques cannot create the illusion that that particular object is coming into the audience into the foreground. This has eliminated or substantially limited the ability to see depth past the sides of the screen window, or outside the view of the window.

As a result, typically objects that are considered to be in positive space are limited to objects that are in the center of the screen. Anytime the object hits the boundaries the screen, i.e. top, bottom, left, right, it will not be seen as projecting into the viewer space.

Objects which are conceptually clipped by the screen mask, make the image appear to have portions that are missing. Once these portions appear to be missing, a viewer's ability to see the object in positive space is inhibited by their brain's inability to envision the clipped object as three dimensional because there are portions behind the mask.

### BRIEF SUMMARY OF THE INVENTION

The present invention is directed to systems and methods that implement a boundary mask on one or more edges of an image display screen to enhance visual properties of objects intersecting an edge of the image display screen. Implementing such boundaries permits embodiments of the present invention to display portions of an object which is otherwise outside of the edge of the screen. This illumination will allow more accurate 3-D viewing of objects that intersect an edge of the screen or are adjacent to an edge of the screen.

In some embodiments of the present invention, a boundary mask comprises a black mask. These embodiments may include display devices which display the black mask along with the main image and allow the main image to be at least partially written onto the black mask.

Further, some embodiments of the present invention may include filling techniques to process information and/or create portions of an image within the digital boundary. Some techniques may include temporal filling, spatial filling, or various animation techniques. Further, in some embodiments, the original image is created in a larger area than an anticipated screen size, as a result filling techniques use the information already present, which may have otherwise been cropped by the image boundary.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a front view of an exemplary display device, according to embodiment of the present invention;

FIG. 2 is a side view of the device illustrated in FIG. 1;

FIG. 3 depicts an exemplary display device, accordance to embodiments of the present invention;

FIG. 4 depicts an exemplary display device, according to embodiments of the present invention; and

FIG. 5 depicts a block diagram of a computer system which is adapted to use the present invention.

### DETAILED DESCRIPTION OF THE INVENTION

It is noted that the discussion herein references a front projection system such as found in a traditional movie theatre. However, this is not intended to limit the scope of embodiments of the present invention to implementation on such a device. Rather, it is done by way of example only as embodiments of the invention may be used with other types of displays. Various types of displays or projection devices are able to implement the features outlined in the present application including, but not limited to, theatrical screens and projection systems, liquid crystal displays (LCD), plasma screens, CRT displays, LED displays, rear-projection systems, DLP devices, multiple component displays and the like.

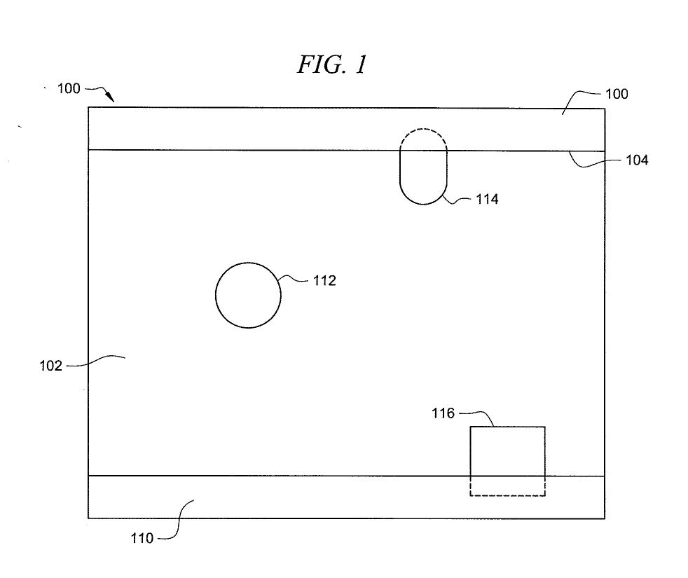

FIG. 1 shows an image display 100 in accordance to an embodiment of the present invention. Display 100 has a normal viewing area 102 with top edge 104 and bottom edge 106. Display 100 also has boundary mask portions 108 and 110 disposed along top edge 104 and bottom edge 106 respectively. Note that boundary mask portions 108 110 are shown by way of example only, as one or more mask portions may be disposed along all or part of any edge of normal viewing area 102. For example, it may be also be advantageous to place a mask portion on along one or both side edges of normal viewing area 102. Such placement will preferably take into account various needs for different 3-D viewing applications.

Boundary mask portions 108 110 may be implemented by displaying black throughout the area of mask portions 108 110. Techniques of displaying a black area are known with respect to different types of display devices. For example, in an LCD a video signal would instruct pixels in the boundary mask portion to not illuminate. In a projection system, light is not projected in the specified area. Using black to fill the mask area is useful for limiting projected light normal viewing area 102. Black in a darkened theater integrates with the darkened room outside the bounds. However, other colors could be used to fill the mask area. For example a grey or charcoal grey may provide better integration with the surrounding environment. Functional, aesthetic, and/or artistic considerations may be taken into account when determining which different colors and/or styles should be used within boundary mask portions 108 110. Additionally, some embodiments may implement multiple colors within boundary mask portions 108 110 to assist in enhancing an overall viewing experience and integrating with the surrounding textures, images and colors. A boundary includes an original image bounds or image mask that is a visually usable area extending beyond boundaries of a principal image. Note that a boundary may be a physical location a screen or may be a portion of the image. Note that the objects may not be limited to static clipped objects, but can also include partial whole objects that dynamically move from the visible portion of the image into one or more edges of the image. When the object intersects the boundary, they would normally become occluded, but with embodiments of the invention, the object is seen as an object that continues its trajectory and/or position in 3D space in their entirety. Also note that the mask may be described as a digital mask or a projected mask.

Boundary mask portions such as portions 108, 110 of FIG. 1 allow for enhanced 3-D image viewing of objects that are intersecting edges 104, 106 of normal viewing area 102. For example, image display 100 contains three image objects 112, 114, 116. Image object 112 is in the center of normal viewing area 102, while objects 114, 116 are intersecting edges 104, 106 causing objects 114, 116 to be partially clipped. In 3-D space, objects 112, 114, 116 can either appear to come in or out of the screen. For this example objects 112 and 114 are coming out of display 100 towards a viewer, while object 116 is pushed back into display 100.

There is an inherent difficulty with pulling a slightly clipped object, such as circular shaped object 114, out of display 100 due to the fact that it is partially clipped by edge 104 and boundary mask portion 108. Because object 114 does not look like a full circle, a viewer's brain will see that object 114 is occluded by boundary mask 108, and will therefore see object 114 as being behind boundary mask 108 mask. Embodiments of the present invention are configured to fill clipped portions such as in object 114 using the area of boundary mask 108, thereby allowing a viewer to perceive object 114 as being in front of display 100.

Object 116 is also clipped by boundary mask 110. However, object 116 is meant to be shown as behind the screen, and the clipping effect from the intersection of object 116 with edge 106 and boundary mask 110 will cause a viewer to think that object 116 is behind the screen. Thus, object 116 will appear to be in a conceptually correct position.

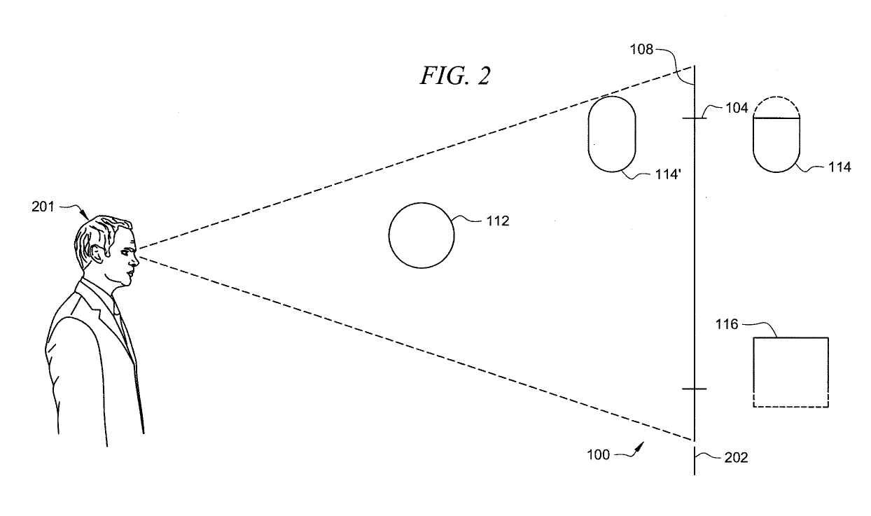

FIG. 2 shows a side view of what viewer 201 would see when observing display 100 in 3-D space. Object 112 is shown as appearing to be coming out in front of a plane defined at 202, which is known as positive 3-D. Object 112, being in the center of normal viewing area 102, appears as expected without any clipping effects.

Object 116 appears behind plane 202, which is known as negative 3-D. Clipped portions of object 116 are illustrated by dashed lines. Despite the fact that object 116 is partially clipped, because it is meant to be behind plane 202, viewer 201 will see object 116 in its proper location with 3-D space.

Viewer 201 sees object 114 as clipped by edge 104 and mask 108, and as a result, viewer 201 will perceive object 114 as being behind plane 202. Object 114′ illustrates the intended viewing position of object 114. To allow viewer 201 to see object 114 in its intended position in front of the screen embodiments of the present invention utilize boundary mask portion 108 to fill in the missing information of 114′ (as denoted by the dashed line area). Once the missing information is filled in, object 114 will be seen by viewer 201 in its proper location, namely as 114′.

Filing in clipped portions of objects within a mask, as shown above, allows a viewer to see many objects in positive space which would normally be seen as with or behind the plane of the screen. However, the clipped information may not be readily available to the person rendering the 3-D image. To aid in this problem, many different filling techniques may be implemented separately or in combination depending on various situations and needs.

One example technique is temporal filling. Temporal fills generally include searching forward or backward within a sequence and using information gained from the search to determine the desired information. For example, an object, such as object 114, may be in motion such that when viewing frames that are forward or backward in time, the entire object is visible at one point. Hence, the desired information missing from an object is found in a different frame and can be used to fill in missing information, either directly or via transformations of the image data, in the event that an object becomes clipped.

Missing information may also be filled using various animation techniques. For example, classical extensions using CG modeling techniques or painting techniques to generate extensions of object and extensions of sets can be used. Green screen techniques could also be used to insert object information. Artists could manually duplicate an object using flow creation techniques, or just by simply estimating how the missing information should appear.

The most simple technique that could be implemented for filling clipped object information could come about if at the inception of the image creation, the image is or was created in a larger aspect ratio than is intended for viewing. For example, if a final image or set of images are to be viewed in a 16:9 aspect ratio (or a 4×3 aspect ratio), creating the images with a larger aspect ratio necessarily causes extra information to exist. This extra information is generally cropped to fit the format size. However, embodiments of the present invention can utilize the information which is to be cropped as fill information for objects which will experience clipping. Note that embodiments of the invention may involve the change in scale as well as the aspect ratio.

One skilled in the art will appreciate that there are many methods and means currently existing, and some that will later be developed, to obtain the desired information for filling a clipped object. The present invention is not limited to any particular filling technique.

Some embodiments will also implement rotoscoping techniques to objects which are occluded because of edge intersection because they may need to be very discretely cut from the material in order to allow them to be placed in front of this clipping mask. Rotoscoping creates the outline of the object based on interpretation or artistic opinion as to what the outline “should” look like for the clipped portions of an object, or by reference to the last seen unclipped version of the clipped object. Hence, it may be helpful to use tools which define the bounds of an object clearly because in the event that the object intersects the edge of the viewing area and mask area. These tools may also comprise of keying or matting techniques to generate said bounding definition.

In some embodiments, filling and/or rotoscoping techniques, such as the ones discussed above, are implemented on a processor-based system having memory, a display, and at least one user interface. Such a system may be configured to execute software configured to implement said techniques.

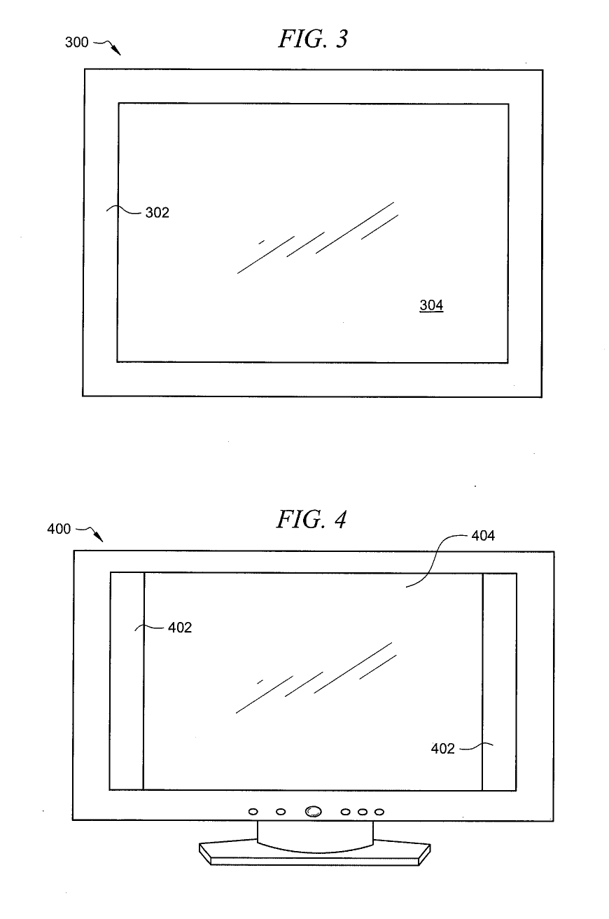

FIGS. 3 and 4 illustrate example embodiments of displays which may be used to implement the present invention. FIG. 3 shows a projection screen 300, such as the type which may be found in a movie theater, home theater, or theme park. Normally such screens would have a physical mask, such as a curtain, to cover boundary mask area 302. However, in the embodiment shown in FIG. 3, boundary mask area is projected along with the contents of the image in main display portion 304. Boundary mask area 302 is shown as circumferentially framing main display portion 302. It is noted that boundary mask portion may extend along all or just part of main display portion 304. Various settings may involve different considerations and call for differing layouts. Note that embodiments of the invention may have the boundary mask area 302 located flush with the main display portion (i.e. equal distant to the user). Alternatively, the boundary mask area 302 may be raised from the main display portion (i.e. closer to the user), or the boundary mask area 302 may be sunk into the main display portion (i.e. farther from the user).

FIG. 4 shows an alternative display screen 400 which may be part of a plasma or LCD type display. Mask portions 402 are shown extending along the side edges of main viewing area 404. The illumination, or lack of illumination of mask portions 402 may be controlled along with the other portions of the display which are responsible for displaying images. Alternatively, mask portions 402 may be separately controlled (this is true as with all embodiments). Again, mask portions are shown only on the sides of main viewing area 404, but may be implemented at any part of the edges in various embodiments.

Note that any of the functions described herein may be implemented in hardware, software, and/or firmware, and/or any combination thereof. When implemented in software, the elements of the present invention are essentially the code segments to perform the necessary tasks. The program or code segments can be stored in a processor readable medium or transmitted by a computer data signal. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, etc. The computer data signal may include any signal that can propagate over a transmission medium such as electronic network channels, optical fibers, air, electromagnetic, RF links, etc. The code segments may be downloaded via computer networks such as the Internet, Intranet, etc.

Note that the object being manipulated may not have been part of the original image. The object may be added to the image and partially or completely be displayed in the mask portion. Note that embodiments of the invention may be asymmetrically applied. The effect may be on one of the display or screen edges and not the others, for example, one of the top or bottom. The mask may be shapes other than a rectangle. For example, the mask may be shaped like a triangle, oval, other polygon, or irregular shape. Further note embodiments of the invention will operate for images in positive 3D space, negative 3D space, or both. Further note that the mask may be resized dynamically. The could occur over a single frame, e.g. 1/24 of a second, or over several frames, or even several seconds. This would allow the effect to be added in over time, if an artist wanted to have all the usable screen for the scenes on a movie that did not need the mask.

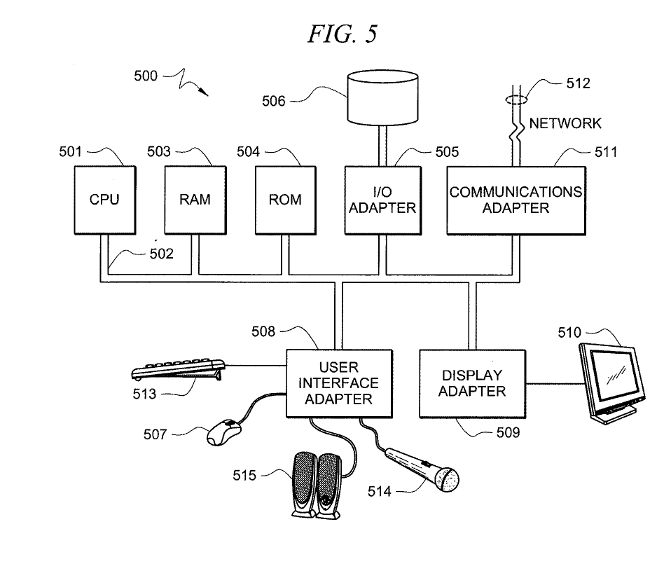

FIG. 5 illustrates computer system 500 adapted to use the present invention. Central processing unit (CPU) 501 is coupled to system bus 502. The CPU 501 may be any general purpose CPU, such as an HP PA-8500 or Intel Pentium processor. However, the present invention is not restricted by the architecture of CPU 501 as long as CPU 501 supports the inventive operations as described herein. Bus 502 is coupled to random access memory (RAM) 503, which may be SRAM, DRAM, or SDRAM. ROM 504 is also coupled to bus 502, which may be PROM, EPROM, or EEPROM. RAM 503 and ROM 504 hold user and system data and programs as is well known in the art.

Bus 502 is also coupled to input/output (I/O) controller card 505, communications adapter card 511, user interface card 508, and display card 509. The I/O adapter card 505 connects to storage devices 506, such as one or more of a hard drive, a CD drive, a floppy disk drive, a tape drive, to the computer system. The I/O adapter 505 is also connected to printer 514, which would allow the system to print paper copies of information such as document, photographs, articles, etc. Note that the printer may a printer (e.g. inkjet, laser, etc.), a fax machine, or a copier machine. Communications card 511 is adapted to couple the computer system 500 to a network 512, which may be one or more of a telephone network, a local (LAN) and/or a wide-area (WAN) network, an Ethernet network, and/or the Internet network. User interface card 508 couples user input devices, such as keyboard 513, pointing device 507, and microphone 516, to the computer system 500. User interface card 508 also provides sound output to a user via speaker(s) 515. The display card 509 is driven by CPU 501 to control the display on display device 510.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for displaying an object in an image comprising:
providing a boundary mask at least partially extending along one or more boundaries of an image display; and
illuminating a portion of said boundary mask to display at least one object in the image that would be at least partially clipped as a result of intersecting with said boundary mask.

2. The method of claim 1 wherein said boundary mask is black.

3. The method of claim 1, wherein the object is fully clipped by the boundary mask portion.

4. The method of claim 1, wherein the object is a new object not originally located within the image.

5. The method of claim 1 wherein said boundary mask is projected with said image.

6. The method of claim 1, wherein said boundary mask is a portion of a screen onto which said image is displayed.

7. The method of claim 1 wherein said boundary mask circumferentially frames said image display.

8. The method of claim 1 wherein said image is a 3-D image and said illuminating allows clipped objects to be perceived in positive 3-D space.

9. A method for rendering an object in 3-D that intersects an edge of a display, said method comprising:
providing a mask on at least one edge of said display; and
using said mask to provide a 3-D effect to said object that at least partially intersects said at least one edge of said display.

10. The method of claim 9 wherein using said mask to provide the 3-D effect comprises:
filling information missing from said object as a result of said intersecting of said display.

11. The method of claim 10 wherein filling comprises at least one of :
using temporal fill techniques, using animation techniques, and using cropped portions of an original image.

12. The method of claim 6, wherein the object is a new object not originally located within the image.

13. An apparatus for displaying an image, said apparatus comprising:
a main viewing surface configured to display images; and
a mask framing at least one boundary of said viewing surface, said mask configured to function to at least partially display an object in the image crossing said at least one boundary.

14. The apparatus of claim 13 wherein said main viewing surface is a screen in a projection system and said mask is projected by a projector configured to project one or more images.

15. The apparatus of claim 13 wherein said main viewing surface and said mask are part of one of an LCD display, a plasma display, and a DLP display.

16. The apparatus of claim 13 wherein said mask is part of the main viewing surface.

17. The apparatus of claim 10, wherein the mask is outside of the main viewing area.

18. The apparatus of claim 13 wherein said images are 3-D images.

19. A method of rendering a 3-D image, said method comprising:
providing an image having at least one object that intersects a periphery of said image; and
filling at least a portion of image information which is partially occluded as a result of intersecting said periphery of said image.

20. The method of claim 19 wherein the providing the image comprises:
providing an image having an aspect ratio greater than an intended final aspect ratio of said image,
wherein said periphery is the periphery of said intended final aspect ratio.

21. The method of claim 15 further comprising:
using a portion of the image information from the greater aspect ratio image for said filling.

22. The method of claim 15 further comprising:
using a portion of the image information from the greater aspect ratio image for scaling the image.
